(19) United States
(12) Patent Application Publication
(10) Pub. No.: US 2009/0012825 A1
(43) Pub. Date: Jan. 8, 2009

(54) Method for determining and/or managing corrosion and/or contamination

(76) Inventor: Ik-Hau Ng, Plymouth, MN (US)

Correspondence Address: ROETZEL AND ANDRESS, 222 SOUTH MAIN STREET, AKRON, OH, 44308, US

(21) Appl. No.: 11/708,173

(22) Filed: Feb. 20, 2007

(51) Int. Cl. G06Q 10/00; G06Q 50/00

(52) U.S. Cl. 705/7

(57) ABSTRACT

The present invention generally relates to methods for determining and/or managing corrosion and/or contamination. More specifically, the present invention relates to various methods to identify, determine and/or quantify the nature, amount and/or extent of corrosion and/or contamination situations, issues and/or concerns in various commercial, production and/or industrial supply chains. In another embodiment, the present invention permits one to identify, determine and/or quantify the nature, amount and/or extent of corrosion and/or contamination situations, issues and/or concerns in various commercial and/or industrial supply chains and recommends various methods by which to mitigate, reduce and/or eliminate such corrosion and/or contamination. In still another embodiment, the present invention provides a method for matching and/or developing specific products, systems, and/or services to solve, address and/or identify corrosion and/or contamination situations, issues and/or concerns.

### FIELD OF THE INVENTION

The present invention generally relates to methods for determining and/or managing corrosion and/or contamination. More specifically, the present invention relates to various methods to identify, determine and/or quantify the nature, amount and/or extent of corrosion and/or contamination situations, issues and/or concerns in various commercial, production and/or industrial supply chains. In another embodiment, the present invention permits one to identify, determine and/or quantify the nature, amount and/or extent of corrosion and/or contamination situations, issues and/or concerns in various commercial and/or industrial supply chains and recommends various methods by which to mitigate, reduce and/or eliminate such corrosion and/or contamination. In still another embodiment, the present invention provides a method for matching and/or developing specific products, systems, and/or services to solve, address and/or identify corrosion and/or contamination situations, issues and/or concerns.

### BACKGROUND OF THE INVENTION

Today, in commerce and industry, a manufacturer's, distributor's or retailer's production and/or supply chain can extend all over the world. As such, components used in one or more manufacturing processes, or completed products, are generally shipped from various global locations to one or more assembly plants or retail locations. Given the wide range of various supply chains, it is becoming more important to manage various corrosion and/or contamination situations, issues and/or concerns, including tarnishing, that can affect one or more types of metals.

Typically, ferrous metals (e.g., iron, steel, cast iron, etc.) are the most susceptible to corrosion. However, other metals such as non ferrous (e.g., aluminum, copper, bronze, etc.) and/or precious metals (e.g., silver) are also susceptible to corrosion. As such, a method that permits one to identify, determine and/or quantify the nature, amount and/or extent of corrosion and/or contamination situations, issues and/or concerns in various commercial and/or industrial supply chains would be useful. Additionally, a method that permits one to identify, determine and/or quantify the nature, amount and/or extent of corrosion and/or contamination situations, issues and/or concerns in various commercial and/or industrial supply chains and recommends various methods by which to mitigate, reduce and/or eliminate such corrosion.

Thus, there is a need for a system and/or method that permits one to identify, determine and/or quantify the nature, amount and/or extent of corrosion and/or contamination situations, issues and/or concerns in various commercial, production and/or industrial supply chains. Additionally, there is also a need for a system and/or method that recommends various methods by which to mitigate, reduce and/or eliminate such corrosion and/or contamination.

### SUMMARY OF THE INVENTION

The present invention generally relates to methods for determining and/or managing corrosion and/or contamination. More specifically, the present invention relates to various methods to identify, determine and/or quantify the nature, amount and/or extent of corrosion and/or contamination situations, issues and/or concerns in various commercial, production and/or industrial supply chains. In another embodiment, the present invention permits one to identify, determine and/or quantify the nature, amount and/or extent of corrosion and/or contamination situations, issues and/or concerns in various commercial and/or industrial supply chains and recommends various methods by which to mitigate, reduce and/or eliminate such corrosion and/or contamination. In still another embodiment, the present invention provides a method for matching and/or developing specific products, systems, and/or services to solve, address and/or identify corrosion and/or contamination situations, issues and/or concerns.

In one embodiment, the present invention relates to a system for managing, mitigating, reducing, and/or eliminating corrosion in various supply chains, production chains and/or manufacturing chains comprising the steps of: (A) determining the nature of the component, or product, to be protected; (B) creating at least one deployment proposal and/or deployment quote; (C) creating at least one deployment recommendation, where such deployment recommendation involves modifying or creating at least one corrosion management plan; (D) implementing the at least one deployment recommendation; and (E) monitoring the effectiveness of the at least one deployment recommendation.

In another embodiment, the present invention relates to a system for managing, mitigating, reducing, and/or eliminating corrosion in various supply chains, production chains and/or manufacturing chains comprising the steps of: (a) determining the nature of the component, or product, to be protected; (b) creating at least one deployment proposal; (c) creating at least one deployment quote; (d) creating at least one deployment recommendation, where such deployment recommendation involves modifying or creating at least one corrosion management plan; (e) implementing the at least one deployment recommendation; and (f) monitoring the effectiveness of the at least one deployment recommendation.

In still another embodiment, the present invention relates to a system for managing, mitigating, reducing, and/or eliminating corrosion in various supply chains, production chains and/or manufacturing chains comprising the steps of: (i) determining the nature of the component, or product, to be protected; (ii) creating at least one deployment proposal and/or deployment quote; (iii) creating at least one deployment recommendation, where such deployment recommendation involves modifying or creating at least one corrosion management plan; (iv) implementing the at least one deployment recommendation; and (v) monitoring, at least one time, the effectiveness of the at least one deployment recommendation.

In still yet another embodiment, the present invention relates to a system for managing, mitigating, reducing, and/or eliminating contamination in various supply chains, production chains and/or manufacturing chains comprising the steps of: (I) determining the nature of the component, or product, to be protected; (II) creating at least one deployment proposal and/or deployment quote; (III) creating at least one deployment recommendation, where such deployment recommendation involves modifying or creating at least one contamination management, reduction and/or elimination plan; (IV) implementing the at least one deployment recommendation; and (V) monitoring the effectiveness of the at least one deployment recommendation.

### BRIEF DESCRIPTION OF THE DRAWINGS

FIG. 1 is a flow chart that illustrates one possible process flow for a method to determining and managing corrosion and/or contamination in accordance with the present invention; and

FIG. 2 is a flow chart that illustrates another possible process flow for one method to determining and managing corrosion and/or contamination in accordance with the present invention.

### DETAILED DESCRIPTION OF THE PRESENT INVENTION

The present invention generally relates to methods for determining and/or managing corrosion and/or contamination. More specifically, the present invention relates to various methods to identify, determine and/or quantify the nature, amount and/or extent of corrosion and/or contamination situations, issues and/or concerns in various commercial, production and/or industrial supply chains. In another embodiment, the present invention permits one to identify, determine and/or quantify the nature, amount and/or extent of corrosion and/or contamination situations, issues and/or concerns in various commercial and/or industrial supply chains and recommends, or “designs to deliver”, various methods, or systems, by which to mitigate, reduce and/or eliminate such corrosion and/or contamination. In still another embodiment, the present invention provides a method for matching and/or developing specific products, systems, and/or services to solve, address and/or identify corrosion and/or contamination situations, issues and/or concerns.

In another embodiment, the present invention relates to methods and/or systems designed to mitigate and/or remove contaminants for one or more environments. Such contaminants include, but are not limited to, corrosive elements, mold, fungus, bacteria, viruses, static charge or discharge, unwanted electrical charges, stray currents or voltage, etc. In still another embodiment, the present invention can also include the use of one or more cleaning systems, fluid management systems, coating systems, or a combination thereof.

In yet another embodiment, the present invention permits one to identify corrosion and/or contamination situations, issues and/or concerns, generate data relating to such situations, issues and/or concerns, where the data generated enables one to determine one or more ways in which to mitigate, control, and/or prevent any corrosion and/or contamination situations, issues and/or concerns so identified.

Additionally, as used throughout the text and claims, corrosion includes not only tarnishing, rusting and other forms of corrosion, but also includes any detrimental or unwanted degradation of an article to be protected. As such, when the phrases “corrosion inhibiting compound(s)” or “corrosion inhibitor(s)” are used herein, these phrases also include tarnish inhibiting compound(s) or tarnish inhibitor(s). In one embodiment, the corrosion inhibiting compound or compounds utilized in conjunction with the present invention are volatile inhibitors. A volatile inhibitor is a compound, or a mixture of compounds, with a finite vapor pressure which, under a given set of conditions, can generate vapors which may or may not condense on any surface with which the vapors come into contact. Generally, the lower a compound's or a mixture's vapor pressure the more difficult it is to generate vapors from such a compound or mixture.

It should be noted that the present invention is not limited to solely systems or methods for determining and/or managing corrosion that utilize one or more volatile corrosion inhibitors. Rather, any suitable type of corrosion inhibitor can be utilized in conjunction with the present invention.

Generally, a suitable corrosion inhibiting systems for use in conjunction with the present invention's systems or methods for determining and/or managing corrosion contain, at a minimum, the following components: (1) at least one source of one or more corrosion inhibiting compounds; and (2) a means for deploying the one or more corrosion inhibiting compounds to an enclosure, component and/or finished product. Optionally, a system in accordance with the present invention can contain, in addition to the elements listed above, at least one dehumidifying means and/or at least one heat source. Suitable deployment means for such corrosion inhibiting compounds include, but are not limited to, capsules, trays, packaging (e.g., film-based packaging, impregnated cardboard packaging, impregnated cardboard or paper sheets, etc.), coatings, gels, liquids, or combinations of two or more thereof.

As would be appreciated by those of skill in the art, any corrosion inhibitor, volatile or otherwise, can be used in conjunction with the present invention's systems or methods for determining and/or managing corrosion. Although suitable volatile corrosion inhibitors are discussed below, the present invention is not limited thereto.

### I. VOLATILIZABLE COMPOUNDS

As is noted above, the systems, according to the present invention, include therein at least one volatilizable compound and/or formula. In another embodiment, the present invention includes therein at least one volatilizable inhibiting compound and/or formula. Any compound which can be volatilized can be used in the present invention, whether solid or liquid. In another embodiment, the one or more volatilizable compounds or formulas of the present invention can be contained in any suitable polymer or polymer film, foam, powder, tablet (e.g., the polymer can be a polyolefin or any suitable biodegradable polymer, such as a biodegradable polyester or copolyester polymer). Suitable types of volatilizable compounds and/or formulas include volatile corrosion inhibitors, volatile tarnish inhibitors, anti-oxidants, anti-mildew, anti-bacterials and/or UV-protectants.

In one embodiment, any compound which is to be utilized in the present invention should generate a sufficient partial pressure at a temperature in the range of about 40° C. to about 90° C., or about 45° C. to about 85° C., or even from about 50° C. to about 80° C. In another embodiment, the partial pressure of the one or more volatilizable compounds should be at least about 3 to 100 times higher than the partial pressure of the one or more volatilizable compounds at 25° C.

In still another embodiment, the partial pressure of the one or more volatilizable compounds should be at least about 100 Pascals (Pa) instead of about 1 Pa, at least about 5 Pa instead of about 0.1 Pa, or even at least about 10⁻² Pa instead of about 10⁻³ Pa, at any temperature within the above stated temperature ranges. A chart detailing vapor pressure for various inorganic and organic compounds and their partial pressures, or even greater than atmospheric pressures, at certain temperatures can be found in the CRC Handbook of Chemistry and Physics, 67th Edition, pages D-192 through D-212, which is hereby incorporated by reference for its disclosure relating to vapor pressure. Additional vapor pressure related material may also be found in the CRC Handbook of Chemistry and Physics, 77th Edition, pages 6-67 through 6-113, which is hereby incorporated by reference for its disclosure relating to vapor pressure.

In one embodiment, the present invention contains therein one or more volatilizable corrosion and/or tarnish inhibiting compounds or formulas.

A. Corrosion Inhibiting and Tarnish Inhibiting Compounds or Formulas:

The following formulas are exemplary corrosion inhibiting and/or tarnish inhibiting compounds or formulas and the present invention is not limited solely to the following compounds and/or formulas.

Any suitable corrosion inhibitor can be used in the present invention. U.S. Pat. Nos. 4,290,912; 5,320,778; and 5,855,975 disclose vapor phase or volatile corrosion inhibitors and are incorporated herein by reference in their entirety for their teachings of such compounds. For example, useful vapor phase or volatile corrosion inhibitors include, but are not limited to, benzotriazole, and mixtures of benzoates of amine salts with benzotriazole, nitrates of amine salts and C₁₃H₂₆O₂N, certain amines and imines, imidazolines and/or imidazoles, triazoloes, pyridines, amides, phosphonates, and sulphonates and their derivatives. Other suitable corrosion inhibitors are described in Corrosion Inhibitors: Principle and Applications, V. S. Sastri, Wiley, New York, N.Y., 1998.

Alternatively, the present invention can utilize a biodegradable polymer-corrosion inhibitor combination as is disclosed in United States Published Patent Application No. 2004/0173779, which is incorporated herein in its entirety for its teaching of biodegradable polymer-corrosion inhibitor combinations. In still another embodiment, the present invention can utilize polymer miscible corrosion inhibiting compositions such as those disclosed in United States Published Patent Application No. 2004/0069972, which is incorporated herein in its entirety for its teaching of corrosion inhibiting compositions. In yet another embodiment, the present invention can utilize any of the corrosion inhibiting formulas and/or compounds disclosed in United States Published Patent Application No. 2003/0213936, which is incorporated herein in its entirety for its teaching of corrosion inhibiting compositions. In still yet another embodiment, the present invention can utilize a tarnish inhibiting compound or formula as disclosed in United States Published Patent Application Nos. 2004/00063837 and 2003/0207974, which are both incorporated in their entireties for their teachings of tarnish inhibiting compounds and/or formulas.

1. Exemplary Corrosion Inhibiting Formulas:

In one embodiment, a suitable corrosion inhibiting formula for inclusion into the present invention comprises a mixture of: (1a) at least one volatile corrosion inhibitor (VCI); (1b) at least one anti-oxidant; (1c) at least one alkali or alkaline-earth metal silicate or oxide; and (1d) fumed silica.

In another embodiment, the corrosion inhibiting formula comprises a mixture of: (2a) at least one volatile corrosion inhibitor (VCI); (2b) at least one anti-oxidant; (2c) at least one alkali or alkaline-earth metal silicate or oxide; (2d) fumed silica; and (2e) at least one chemically active compound.

In yet another embodiment, the corrosion inhibiting formula comprises a mixture of: (3a) an inorganic nitrite salt; (3b) a phenol represented by the formula:

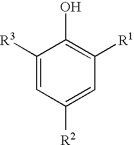

where R¹, R² and R³ are selected from alkyl, aryl, alkenyl, hydroxyalkyl, hydroxyalkenyl and where the sum of carbon atoms in R¹, R² and R³ is in the range of 3 to about 18; and (3c) fumed silica. All of the mixtures described above can further include additional additives.

### a. VOLATILE CORROSION INHIBITORS

Any suitable volatile corrosion inhibitor (or vapor phase corrosion inhibitor) can be utilized in the at least one corrosion inhibiting formula contained in the present invention. As is noted above, some suitable volatile corrosion inhibitors are disclosed in U.S. Pat. Nos. 4,290,912; 5,320,778; and 5,855,975, which are all incorporated herein by reference in their entirety for their teachings of such inhibitors. For example, useful vapor phase or volatile corrosion inhibitors include, but are not limited to, triazoles and/or inorganic nitrites (e.g., nitrite salts).

In one embodiment, exemplary inorganic nitrite salts include, but are not limited to, metal nitrites, such as sodium nitrite, potassium nitrite and barium nitrite. In another embodiment, any suitable Group 1 or Group 2 nitrite (New Notation System) can be used in the at least one corrosion inhibiting formula contained in the present invention.

In another embodiment, the one or more vapor phases or volatile corrosion inhibitors utilized in the present invention can be a triazole. Exemplary triazoles include, but are not limited to, benzotriazole, tolyltriazole and/or sodium tolyltriazole.

In yet another embodiment, the vapor phase or volatile corrosion inhibitor utilized in the present invention can be any suitable mixture of two or more of the above-mentioned inhibitors.

### b. ANTI-OXIDANTS

Any suitable anti-oxidant can be utilized in the at least one corrosion inhibiting formula contained in the present invention. Exemplary anti-oxidants include, but are not limited to, tri-substituted phenols independently substituted in the 2, 4 and 6 positions with one or more alkyl, hydroxyalkyl, aryl, alkenyl or hydroxyalkenyl groups of the general formula shown below.

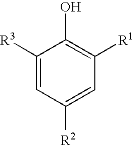

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the at least one corrosion inhibiting formula contained in the present invention.

### c. ALKALI/ALKALINE-EARTH METAL SILICATES/OXIDES

Any suitable Group 1 or 2 silicate or oxide can be utilized in the at least one corrosion inhibiting formula contained in the present invention. Exemplary silicates include lithium silicate, sodium silicate, potassium silicate and barium silicate. With regard to the silicates utilized in the at least one corrosion inhibiting formula contained in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 3:1 to about 1:3.

In another embodiment, a mixture of one or more silicates can be utilized in the at least one corrosion inhibiting formula contained in the present invention. In yet another embodiment, the one or more silicates can be in a glassy or crystalline state.

In yet another embodiment, at least one alkali or alkaline-earth metal oxide is utilized in the at least one corrosion inhibiting formula contained in the present invention rather than, or in addition to, the one or more silicates discussed above. Exemplary alkali and alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one corrosion inhibiting formula of the present invention.

### d. FUMED SILICA

Any suitable fumed silica can be utilized in the at least one corrosion inhibiting formula contained in the present invention. Suitable fumed silicas are available under the tradenames Cab-O-Sil from Cabot Corporation and Aerosil from American Cyanamid.

### e. CHEMICALLY ACTIVE COMPOUND

If present, the at least one chemically active compound utilized in the at least one corrosion inhibiting formula contained in the present invention can be an oxide compound, or combination thereof, which can react with one or more compounds to form compounds which are insoluble in aqueous environments. Exemplary chemically active compounds include, but are not limited to, iron oxides (both ferrous oxide and ferric oxide), cobalt oxide, nickel oxide, copper oxides (both cuprous oxide and cupric oxide) and zinc oxide.

In another embodiment, mixtures of two or more of the above-mentioned oxides can be utilized.

### f. ADDITIONAL ADDITIVES

In addition to components (1a) to (1d) (or (2a) to (2e)), the at least one corrosion inhibiting formula contained in the present invention may also contain other additives, such as UV-protectants, anti-bacterials, anti-mildews, etc.

In one embodiment, the one or more corrosion inhibiting formulas contained in the present invention are acid-free (i.e., the mixtures contain an amount, if any, of acidic compounds which does not adversely affect the final pH of the corrosion inhibiting formulas of the present invention). For example, in one embodiment, acid free can mean having a pH of more than about 5, or more than about 6, or even more than about 7.

In another embodiment, the one or more corrosion inhibiting formulas contained in the present invention optionally contain at least one odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

### g. EXAMPLES

The above corrosion inhibiting formulas are further illustrated by the following examples wherein the term “parts” refers to parts by weight unless otherwise indicated. The following examples are not meant to be limiting, rather they are illustrative of only a few embodiments within the scope of the present invention.

Examples A-1 to A-3 describe the preparation of corrosion inhibiting formulas.

### Example A-1

| | |
|---|---|
| Sodium Nitrate | 2.5 Parts |
| Sodium Silicate¹ | 0.2 parts |
| “Ionol”² | 0.5 parts |
| “Cab-O-Sil”³ | 0.1 parts |

¹Sodium Silicate is a glassy product with a weight ratio of silica to sodium oxide of 2 (commercially available from the PQ Corporation).
²“lonol” is 2,6-di-tert-butyl-4-methyl phenol (commercially available from the Uniroyal Chemical Company).
³“Cab-O-Sil” is fumed silica (commercially available from the Cabot Corporation).

### Example A-2

| | |
|---|---|
| Sodium Nitrite | 2.5 parts |
| Sodium Silicate | 0.2 parts |
| “Cobratec TT-85”⁴ | 0.5 parts |
| “Ionol” | 0.5 parts |
| “Cab-O-Sil” | 0.1 parts |

⁴“Cobratec TT-85” is sodium tolyltriazole, a corrosion inhibitor commercially available from the Sherwin-Williams Company.

### Example A-3

| | |
|---|---|
| Sodium Nitrite | 2.5 parts |
| Sodium Silicate | 0.2 parts |
| “Ionol” | 0.5 parts |
| “Cobratec TT-85” | 0.5 parts |
| Zinc Oxide | 1.0 parts |
| “Cab-O-Sil” | 0.1 parts |

2. Exemplary Tarnish Inhibiting Formulas:

As noted above, in one embodiment, the present invention relates to systems which can contain therein at least one tarnish inhibiting formula which comprises a mixture of: (4a) at least one strong alkali compound; and (4b) at least one compound which yields an insoluble sulfide. This mixture can further include one or more additional additives, such as anti-oxidants, corrosion inhibitors, etc.

### a. STRONG ALKALI COMPOUND

Any suitable Group 1 or 2 silicate or oxide can be utilized in the at least one tarnish inhibiting formula contained in the present invention as component (4a), the at least one strong alkali compound. Exemplary silicates include, but are not limited to, lithium silicate, sodium silicate, potassium silicate and barium silicate. With regard to the silicates utilized in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 2.5:1 to about 1:2.5.

In another embodiment, a mixture of one or more silicates can be used in the at least one tarnish inhibiting formula contained in the present invention. In yet another embodiment, the one or more silicates can be in a glassy or crystalline state.

In yet another embodiment, the at least one alkali or alkaline-earth metal oxide is utilized in the at least one tarnish inhibiting formula contained in the present invention rather than the one or more silicates. Exemplary alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one tarnish inhibiting formula contained in the present invention.

While not wishing to be bound to any one theory, it is believed that the one or more strong alkali compounds react with any hydrogen sulfide (H₂S) and/or any acid compounds present in the environment. This prevents such compounds and/or acids from passing through the polymer matrix of a polymer article which optionally contains therein a tarnish inhibiting formula, according to the present invention.

### b. COMPOUNDS WHICH YIELD INSOLUBLE COMPOUNDS

Any suitable compound which forms an insoluble compound, such as a sulfide (solubility of less than about 0.1 grams/liter of water) when H₂S is present, can be utilized in the at least one tarnish inhibiting formula contained in the present invention as component (4b), the compound which yields an insoluble sulfide. Exemplary compounds include, but are not limited to, compounds containing iron, cobalt, nickel, copper and zinc. Mixtures of two or more such compounds can also be utilized in the at least one tarnish inhibiting formula contained in the present invention. Suitable anions for the compound according to component (4b) include oxides and hydroxides.

Exemplary compounds include, but are not limited to, zinc oxide, zinc hydroxide, iron oxides (both ferrous oxide and ferric oxide), iron hydroxide (Fe(OH)₂), cobalt oxide, cobalt hydroxides (both Co(OH)₂ and CO₂O₃.3H₂O), nickel oxide, nickel (II) hydroxide, copper oxides (both cuprous oxide and cupric oxide) and copper hydroxide. Mixtures of two or more of the above compounds can also be utilized as component (4b).

### c. VOLATILE CORROSION INHIBITORS

In one embodiment, the tarnish inhibiting formula contained in the present invention further includes any suitable volatile corrosion inhibitor (or vapor phase corrosion inhibitor). Some suitable volatile corrosion inhibitors are disclosed in U.S. Pat. Nos. 4,290,912; 5,320,778; and 5,855,975, which are all incorporated herein by reference in their entirety for their teachings of such inhibitors. For example, useful vapor phase or volatile corrosion inhibitors include, but are not limited to, triazoles and/or inorganic nitrites (e.g., nitrite salts).

Exemplary inorganic nitrite salts include, but are not limited to, metal nitrites, such as sodium nitrite, potassium nitrite and barium nitrite. In another embodiment, any suitable Group 1 or Group 2 nitrite (New Notation System) can be used in the one or more tarnish inhibiting formulas contained in the present invention.

In another embodiment, if present, the one or more tarnish inhibiting formulas contained in the present invention can optionally include one or more vapor phase or volatile corrosion inhibitors selected from triazoles. Exemplary triazoles include, but are not limited to, benzotriazole, tolyltriazole and/or sodium tolyltriazole.

In yet another embodiment, the optional vapor phase or volatile corrosion inhibitor utilized in the present invention can be any suitable mixture of two or more of the above-mentioned volatile corrosion inhibitors.

### d. ANTI-OXIDANTS

If desired, any suitable anti-oxidant can be utilized in the tarnish inhibiting portion of the present invention. Exemplary anti-oxidants include, but are not limited to, tri-substituted phenols substituted in the 2, 4 and 6 positions with one or more alkyl, hydroxyalkyl, aryl, alkenyl or hydroxyalkenyl groups of the general formula shown below.

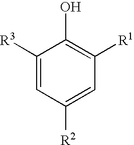

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the tarnish inhibiting portion of the present invention.

### e. ADDITIONAL ADDITIVES

In addition to components (4a) and (4b), the tarnish inhibiting formulas optionally contained in the present invention may also contain other additives such as, UV-protectants, anti-bacterials, anti-mildews, etc.

In one, embodiment, the one or more corrosion inhibiting formulas contained in the present invention are acid-free (i.e., the mixtures contain an amount, if any, of acidic compounds which do not adversely affect the final pH of the corrosion inhibiting formulas of the present invention). For example, in one embodiment, acid free can mean having a pH of more than about 5, or more than about 6, or even more than about 7.

In another embodiment, a tarnish inhibiting formula, according to the present invention, optionally contains an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

### f. EXAMPLES

The above tarnish inhibiting formulas are further illustrated by the following example wherein the term “parts” refers to parts by weight unless otherwise indicated. The following example is not meant to be limiting, rather it is illustrative of only one embodiment within the scope of the present invention.

### Example B-1

(a) The following compounds are mixed to form a tarnish inhibiting formula. This tarnish inhibiting formula is illustrated by the following example wherein the term “parts” refers to parts by weight unless otherwise indicated.

| | |
|---|---|
| Sodium Silicate | 25 parts |
| Zinc Oxide | 25 parts |

3. Other Corrosion Inhibiting Formulas and Compounds:

In yet another embodiment, the present invention relates to systems which contain therein at least one corrosion inhibiting formula which comprises a mixture of: (3a) an inorganic nitrite salt, (3b) a trisubstituted phenol and (3c) fumed silica.

The useful inorganic nitrite salts include metal nitrites (such as Group I and II metal nitrites), including potassium nitrite, sodium nitrite and calcium nitrite. In one embodiment, the nitrite salt is sodium nitrite.

The trisubstituted phenols which are useful are substituted in the 2, 4 and 6 positions with alkyl, hydroxyalkyl, aryl, alkenyl or hydroxyalkenyl. In one embodiment, the phenol is 2,6 di-t-butyl-4-methyl phenol.

Any suitable fumed silica can be utilized. An exemplary fumed silica is available commercially under the tradename “Cab-O-Sil” from the Cabot Corporation.

This corrosion inhibiting formula is further illustrated by means of the following example wherein the term “parts” refers to parts by weight unless otherwise indicated. The following example is not meant to be limiting, rather it is illustrative of only one embodiment within the scope of the present invention.

### Example C-1

| | |
|---|---|
| Sodium Nitrite | 3 parts |
| “Ionol” | 2 parts |
| “Cab-O-Sil” | 0.1 parts |
| Oleyl Alcohol | 3 parts |

### II. HEAT SOURCES

As is noted above, the systems of the present invention optionally contain at least one heat source. Any suitable heat source having a controllable heat output can be utilized in the present invention. Suitable heat sources include, but are not limited to, chemical heat sources (e.g., mixtures of iron powder, water, salt, activated charcoal and vermiculite) which, when exposed to air, undergo a chemical reaction and yield excess heat and battery or fuel powered non-flame heat sources (e.g., a light bulb, a heating element, etc.). One type of heat source which, in most instances, is disfavored for use in the present invention is any type of heat source which generates a flame (e.g., a Sterno can, a Bunsen burner, a cigarette lighter, etc.). This type heat source is generally disfavored for use in the present invention because it could lead to a fire hazard, and the temperature of the heat output is generally difficult to control.

### III. DEHUMIDIFYING MEANS

As is noted above, the systems of the present invention optionally contain at least one dehumidifying means. Any suitable dehumidifying means capable of absorbing, removing and/or chemically binding water and/or water vapor can be utilized in conjunction with the present invention's systems or methods for determining and/or managing corrosion. Suitable dehumidifying means for use in conjunction with the present invention include, but are not limited to, desiccants, battery-operated and/or electrically-operated dehumidifiers, or combinations of two or more thereof.

### IV. EXEMPLARY CORROSION AND/OR CONTAMINANT CONTROL/MITIGATION SYSTEMS

The following is a representative list of exemplary corrosion and/or contaminant control/mitigation systems. However, it should be noted that the present invention is not limited thereto.

The methods of the present invention can utilize, among other things, one or more systems for controlling, mitigating and/or reducing corrosion. Such systems are disclosed in, for example, co-pending U.S. patent application Ser. No. 11/602,129, filed Nov. 20, 2006 and entitled “Systems for Decreasing Environmental Corrosion Factors and/or for Delivering One or More Corrosion Inhibiting Compounds to an Enclosure.” Other suitable systems include corrosion and/or contamination reduction, prevention and/or mitigation systems based on nanotechnology, biodegradable-based systems, cleaning systems, electrical and/or chemically-based systems, etc.

### V. EXEMPLARY EMBODIMENTS

The present invention generally relates to methods for determining and/or managing corrosion and/or contamination. More specifically, the present invention relates to various methods to identify, determine and/or quantify the nature, amount and/or extent of corrosion and/or contamination situations, issues and/or concerns in various commercial, production and/or industrial supply chains, or even storage facilities. In another embodiment, the present invention permits one to identify, determine and/or quantify the nature, amount and/or extent of corrosion and/or contamination situations, issues and/or concerns in various commercial, production and/or industrial supply chains and recommends various methods by which to mitigate, reduce and/or eliminate such corrosion and/or contamination. In still another embodiment, the present invention provides a method for matching and/or developing specific products, systems, and/or services to solve, address and/or identify corrosion and/or contamination situations, issues and/or concerns.

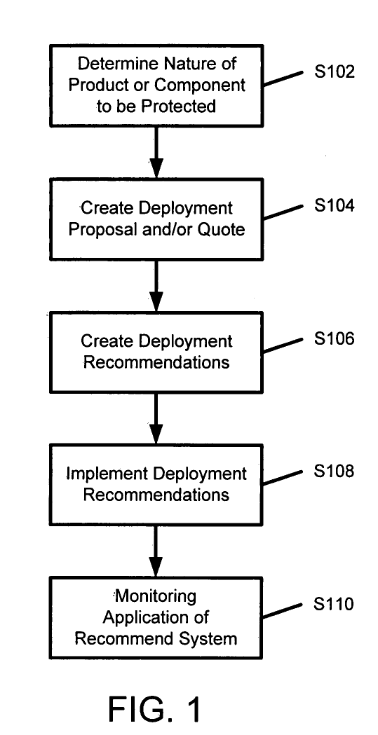

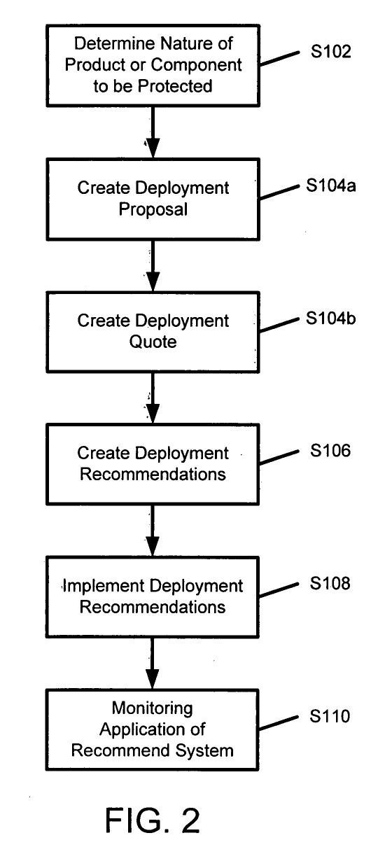

The following discussion relates to exemplary embodiments of the systems or methods for determining and/or managing corrosion and/or contamination situations, issues and/or concerns in accordance with the present invention. However, it should be noted that the present invention is not limited thereto. Additionally, although the embodiments of FIGS. 1 through 2 illustrate only two systems/methods according to the present invention, the present invention contemplates systems and/or methods that contain substantially all of the steps of such methods. For example, a system or method which includes three of four steps of the five and six step methods of FIGS. 1 and 2, are within the scope of the present invention. This is particularly true where the steps deleted are the implementation and/or monitoring steps. Examples of compounds that can be removed, mitigated and/or reduced by the systems or methods of the present invention include, but are not limited to, H₂S, SO₂, CO₂, Cl⁻, and H₂O.

Turning to the Figures, FIG. 1 illustrates a flow chart for one system for determining and/or managing corrosion and/or contamination in accordance with the present invention. In the embodiment of FIG. 1 the system includes Steps 102, 104, 106, 108 and 110.

Turning to each of the individual steps of the system of FIG. 1, the method illustrated in FIG. 1 initially begins with Step 102 by someone determining the nature of the component, or product, to be protected. This is generally accomplished by way of a questionnaire or survey that is completed by someone familiar with either the make-up of the component, or product, to be processed, shipped, transported and/or stored. Generally speaking the person most qualified to complete the questionnaire or survey in connection with Step 102 is someone familiar with the one or more corrosive factors or conditions that affect the component or product of interest.

In one embodiment, Step 102 involves answering the following exemplary questions:

(1) With what component(s) and/or product(s) does a corrosion and/or contamination problem, or problems, exist?;

(2) What type of corrosion and/or contamination susceptible material is the component and/or product made from, or primarily made from (e.g., what type of ferrous, non-ferrous or precious metals are present in the component and/or product, or what type of contamination is occurring and where, if possible, does the contamination emanate from)?;

(3) What type of corrosion and/or contamination protection and/or mitigation, if any, is currently being utilized to protect the component and/or product of interest?;

(4) What is the main reason for seeking corrosion and/or contamination protection of the component and/or product? Is it for shipping, land transportation, long-term storage, in process protection, etc.?;

(5) Please describe your supply chain for the component and/or product. Is it an original equipment manufacturer (OEM), Tier 1, Tier 2, Consolidator/Deconsolidator situation?;

(6) What is the desired corrosion and/or contamination protection period from point of packaging, shipping, or storage to point of use?; and

(7) Is there a “no smoke” requirement for the component and/or product at the point of final use? (By “no smoke” it is meant that the component and/or product can not create, generate and/or cause fumes or smoke when the component and/or product is further processed (e.g., machined) or used in its intended application.)

As would be apparent to those of skill in the art, not all of the above questions need to answered in order to determine the nature and extent of any corrosion and/or contamination situations, issues and/or concerns with the component and/or product to be protected.

Once a picture of the nature of the component and/or product to be protected and the corrosion and/or contamination situations, issues and/or concerns facing such a component and/or product has been developed a Deployment Proposal is created in Step 104. Step 104 is accomplished by a qualified individual who determines, among other things, one or more of the following:

(1) One or more preferred methods by which to implement the proposed corrosion and/or contamination management program. Such methods include, but are not limited to, modifying shipment and/or packaging protocols, procedures or processes, modifying washing process or frequency/cycles of washing, modifying frequency of fluid change during washing, rinsing and/or purifying processes, adding additional corrosion and/or contamination control steps such as an additional wash, sterilization or decontamination step to a process (e.g., some type of radiation-based sterilization, or some type of chemical-based decontamination or sterilization). In another embodiment, such contamination mitigation and/or prevention systems can include, but are not limited to, one or more metal-based contamination control systems (e.g., colloidal silver-based systems), alcohol-based contamination control systems, radiation-based contamination control systems, etc.;

(2) Conducts a process mapping analysis where each point of a supply and/or manufacturing chain is analyzed for various factors relating to potential corrosion. This step will be explained in more detail below, but basically involves determining various corrosion related factors involved in the supply, manufacture, assembly, packaging, shipping, and/or storage of various components and/or finished products;

(3) Conducts a manufacturing control process review in order to determine, at a minimum, if any current corrosion protection methods are being implemented correctly and consistently. This review also looks at how to best implement any additional, or new, corrosion protection given the details gathered in Step 102 relating to the component and/or product to be protected;

(4) Conduct a process failure mode and effects analysis (FMEA). FMEA is a method that examines potential failures in products or processes. It may be used to evaluate risk management priorities for mitigating, in this case, known corrosion vulnerabilities. FMEA helps select remedial actions that reduce the cumulative impacts of corrosion life-cycle consequences (risks) from a systems failure (fault). The basic process is to take a description of the parts of, for example, the supply chain, storage facility or shipment chain for a desired component and/or product, and list the consequences, in terms of corrosion loss potential for each part of the supply chain or shipment chain. This information is then used at a later point to develop, or modify, a corrosion mitigation, reduction and/or elimination plan;

(5) Conduct a packaging review, including a packaging design review;

(6) Conduct an operator/worker review in order to determine what, if any, corrosion preventative and/or mitigation steps are being utilized, and to ascertain if such steps are being applied consistently and correctly;

(7) Conduct corrosion and/or contamination testing on one or more components and/or products. Such testing includes, but is not limited to, chip testing, drop testing, corrosion inhibiting standard test, humidity chamber testing, cyclic climate chamber test, volatile corrosion inhibiting jar test, salt spray chamber test, corrosive gas chamber test, mechanical properties testing, glow residue testing, and/or water vapor transmission testing (WVTT ASTM E-96-00 and/or ASTM E-398-03); and

(8) Conduct process fluids testing; and

(9) Review and analyze data obtained from one or more of points (1) through (8) and then use the analysis and data obtained to generate and/or create a deployment proposal for implementing a new, or improved, corrosion and/or contamination protocol. This may also involve generating and/or creating a deployment quote which contains a cost factor analysis of, for example, the cost of implantation versus the cost savings generated by the new, or improved, corrosion and/or contamination protocol. The review and analysis of the data obtained in Step 104 can be done in one sub-step (see Step 104a of FIG. 2) and used to generate and/or create a deployment proposal for implementing a new, or improved, corrosion and/or contamination protocol. Then, one can subsequently independently generate and/or create a deployment quote (see Step 104b of FIG. 2). Alternatively, these two sub-steps could be combined into one simultaneous step as is shown in Step 104 of FIG. 1.

It should be noted that with regard to steps (7) and (8) immediately above, that any number of testing protocols or standards can be used therein. The nature of the testing protocols or standards utilized is determined by the nature of the component and/or product being reviewed.

Exemplary testing standards, procedures and/or protocols include, but are not limited to, the following tests which are referred to herein by their test numbers and a sometimes truncated title: CEI IEC 68-2-30 (Basic Environmental Testing Procedure—Cyclic), CEI IEC 68-2-60 (Tests—Flowing Mixed Gas Corrosion Test), ANSI/EIA-541-1088 (Packaging Material Standards For ESD Sensitive Items), ASTM B117-97 (Salt Spray Test), ASTM B152/B152 (Standard Specifications for Copper Sheet, Plates and Roll Bar), ASTM B 809-95 (Standard Test for Porosity in Metallic Coatings by Humid Sulfur Vapor), ASTM B 827-97 (Mixed Flowing Gas Test), ASTM B 845-97 (Standard Guide for Mixed Flowing Gas Tests for Electrical Contacts), ASTM D 130 1569 (Detection of Copper Corrosion from Petroleum Products), ASTM D 257-99 (Standard Test Method for DC Resistance or Conductance of Insulating Materials), ASTM D 471-98 (Standard Test Method for Rubber Property—Effect of Liquids), ASTM D 609-95 (Standard Practice for Preparation of Cold-Rolled Steel Panels for Testing Paint, Varnish, Conversion Coatings, and Related), ASTM D 610-01 (Evaluating Degree of Rusting on Painted Steel Surfaces), ASTM D 618-05 (Standard Practice for Conditioning Plastics for Testing), ASTM D 882-01 (Standard Test Method for Tensile Properties of Thin Plastic Sheeting), ASTM D 883-00 (Standard Terminology Relating to Plastics), ASTM D 1067-02 (Standard Test Methods for Acidity or Alkalinity of Water), ASTM D 1193-99 (Standard Specifications for Reagent Water), ASTM D 1234-95 (Dilute Solution Viscosity of Vinyl Chloride Polymers), ASTM D 1293-99 (Standard Test Methods for pH of Water), ASTM D 1709-91 (Standard Test Method for Impact Resistance of Plastic Film by the Free Falling Dart Method), ASTM D 1735-04 (Standard Practices for Testing Resistance Coating—Water Fog), ASTM D 1748 (Rust Protection by Metal Preservative in the Humidity Chamber), ASTM D 1922-03 (Standard Method for Propagation Tear Resistance of Plastic Film), ASTM D 1938-02 (Standard Test Method for Tear Propagation Resistance (Trouser Tear) of Plastic Film and Thin Sheeting by a Single-Tear Method), ASTM D 2017-81 (Standard Method of Accelerated Laboratory Test of Natural Decay Resistance of Woods), ASTM D 2103-03 (Specifications for Polyethylene Film and Sheet), ASTM D 2247-02 (Standard Practice for Testing Water Resistance of Coatings in 100% Relative Humidity), ASTM D 3763-02 (Standard Test Method for High Speed Puncture Properties of Plastics Using Load and Displacement Sensors), ASTM D 4587-91 (Standard Practice for Conducting. Tests on Paint and Related Coatings and Materials Using a Fluorescent UV-Condensation Light- and Water-Exposure Apparatus), ASTM D 4830-98 (Standard Test Method for Characterizing Thermoplastic Fabrics Used in Roofing and Waterproofing), ASTM D 5630-01 (Ash Content in Plastics), ASTM D 5748-95 (Standard Test Method for Protrusion Puncture Resistance of Stretch Wrap Film), ASTM D 5947-03 (Standard Test for Physical Dimension of Solid Plastic), ASTM D 4627 (Iron Chip Corrosion for Water Dilutable Metalworking Fluids), ASTM D 6400 (Specifications for Compostable Plastics), ASTM D 6868-03 (Standard Specifications for Biodegradable Plastics Used as Coatings on Paper and Other Compostable Substrates), ASTM E 96-00 (WVTR of Materials), ASTM E 104-85 (Standard Practices for Maintaining Relative Humidity and Maintaining Constant RH—Aqueous Solution), ASTM E 398-03 (WVTR for Sheet Materials Using Dynamic RH Measurement), ASTM F 119-82 (Standard Test Method for Rate of Grease Penetration of Flexible Barrier Materials (Rapid Method)), ASTM F 372-99 (WVTR of Barrier Materials), ASTM F 1110 (Standard Test Method for Sandwich Corrosion Test), ASTM F 1249-90 (WVTR Plastic Film (IR sensor)), ASTM G-1-90 (Prepare, Clean and Evaluate Corrosion Test Specimens), ASTM G15-99b (Standard Terminology), ASTM G16-95 (Applying Statistics), ASTM G85-98 (Modified Salt Spray), ASTM G87-02 (Standard Practice for Conducting Moist SO₂ Test), ASTM 102-89 (Calculation of Corrosion Rates and Related Information from Electrochemical Measurements), Ministry of Defense 91-72 (Rust Penetrating Oil ZX54 Test), DIN 38404 (Physical and Physicochemical Characteristics; Determination of pH Value), DIN 50018 (SO₂ Corrosion Testing in Saturated Atmosphere), DIN 50021 (Salt Spray Testing), DIN 51360 (Testing of Cooling Lubricants Chip (German)), DIN 527-3 (Tensile Strength), DIN 53122-1 (WVTR), DIN 53370 (Thickness), DIN 53435 (Testing of Plastics, Tensile), DIN IEC 93 (Test for Insulation Materials for Electrical Purposes), GM 4465 (Humidity Fog), ESD-STM11.11-2001 (For the Protection of Electrostatic Discharge Susceptible Items—Surface Resistance Measurement of Static Dissipative Planar Materials), ESD-STM11.31-2001 (For Evaluating the Performance of Electrostatic Discharge Shielding Materials—Bags), SAE J2334 (Cyclic Corrosion Testing), GM 9540P (Cyclic Accelerated Corrosion Exposure), INA test 2 German (QN 5.61-1 Test in German), INA Test German (QN 5.61-1 Excor Version Test in German), IP 287/94 (Iron Chip Corrosion for Water Dilutable Metalworking Fluids), ISO 1183 (Plastics—Methods for Determining the Density of Non-Cellular Plastics), ISO 3451-1 (Plastic Determination of Ash), ISO 9197 (Paper, Board and Pulps—Determination of Water Soluble Chlorides), ISO 9227 (Corrosion Test/Salt Spray), ISO 11925-2 (Reaction to Fire Tests—Ignitability of Building Products Subjected to Direct Impingement of Flame—Part 2: Single-Flame Source Test), EN ISI 10062 (Hydrogen Sulfide Content—Humid Air), EN ISO 11885 (Inductively Coupled Plasma Atomic Emission Spectroscopy), MIL STD 3010 Method 3015 (Delaminating Resistance of Heat-Sealable Films and Barriers), MIL STD 1916 (DOD Preferred Methods for Acceptance of Product), MIL STD 3010 Method 4031 (Jar Test—Test Procedure for Packaging Material—Previously known as FED STD 101C), MIL-B-22020D (Bags, Transparent, Flexible, Sealable, Volatile Corrosion Inhibitor Treated), MIL-PRF-81705D(1) (Barrier Materials Flexible, Electrostatic Protective, Heat Sealable), MIL-C-15074E (Corrosion Preventive, Fingerprint Remover), MIL-PRF-81309F (Corrosion Preventive Compounds, Water Displacing Ultra Thin Film), DOD-P-15328D (Primer (Wash), Pretreatment (Formula No. 117 for Metals)), MIL-I-8835A (Indicator, Humidity, Card, Chemically Impregnated), MIL-I-8574E (Inhibitors, Corrosion, Volatile, Utilization of), MIL-L-87177A (Lubricants, Water Displacing Synthetic), MIL-PRF-121G (Barrier Materials, Greaseproof, Waterproof, Flexible, Heat-Sealable), MIL-PRF-680B (Performance Specification Degreasing Solvent), MIL-PRF-3420G(1) (Packaging, Materials, Volatile Corrosion Inhibitor Treated, Opaque), MIL-PRF-10924G (Grease, Automotive and Artillery), MIL-PRF-16173E (Corrosion Preventive Compound Solvent Cutback, Cold Application), MIL-PRF-22019E (Barrier Materials Transparent, Flexible, Sealable, Volatile Corrosion Inhibitor Treated), MIL-PRF-22191E(1) (Barrier Materials Transparent, Flexible, Sealable), MIL-PRF-46002C (Preservative Oil, Contact and Volatile Corrosion Inhibited), NACE STD TM0169-2000 (Standard Test Methods Laboratory Corrosion Testing of Metals), TL-8135 0002 (Corrosion Inhibiting Paper), TL-8135-0043 (Film for Corrosion Protection (German)), and UK BS 1133: Section 6 1966 (Temporary Protection of Metal Surfaces Against Corrosion (During Transport and Shipment) Packaging Code), all of which are incorporated herein by reference.

In the embodiment where the present invention is directed to a contamination situation, issue and/or concern, the testing conducted in accordance with the methods and/or systems disclosed herein depends on the nature of the contamination at issue. Accordingly, the present invention is not limited to any type of testing. Rather, one of skill in the art would recognize that there are a wide range of testing procedures available to determine the exact nature and/or extent of any contamination situations, issues and/or concerns present. Such testing can include, but is not limited to, culturing, genetic testing, x-ray testing, ultrasonic testing, etc.

Once the above process has been completed in Step 104, this information is in turn used to create, in Step 106, one or more deployment recommendations as to how to specifically implement the new, or improved, corrosion and/or contamination protocol. Such one or more deployment recommendations can include, but are not limited to, revised, improved and/or new packaging guidelines; revised, improved and/or new processing guidelines; revised, improved and/or new component and/or product handling guidelines; revised, improved and/or new corrosion and/or contamination management guidelines; revised, improved and/or new corrosion and/or contamination management implantation procedures and/or guidelines; revised, improved and/or new control processes or plans, revised, improved and/or new operator instructions and/or processes; revised, improved and/or new purchasing processes or procedures; revised, improved and/or new; or combinations of two or more thereof.

It should be noted that in some instances the system and/or method of the present invention can stop after Step 106. This is because some review subjects might be unwilling to implement the recommendations generated by Step 106. Such lack of implementation could be due to any number of factors including, but not limited to, cost factors, time and/or worker effort needed to implement one or more of the recommendations, an unwillingness to change an already engrained corrosion and/or contamination management system, etc. If the review subject, or subjects, is/are willing to implement the one or more deployment recommendations created in Step 106, such implementation takes place in Step 108. Optionally, one-time, multiple-time, or continued/continuous monitoring of the effectiveness and proper implantation of the one or more deployment recommendations created in Step 106 takes place in Step 110.

In light of the above, the system/method of FIG. 2 is identical to that of FIG. 1 except for the individual sub-steps relating to Step 104 of FIG. 1, as is explained above. As such, a detailed explanation of the system/method of FIG. 2 is omitted herein for the sake of brevity.

Turning to the process mapping analysis of the present invention, in one embodiment the following exemplary questions are answered, if possible, by a qualified individual. Here, as well as elsewhere in the specification and claims, the order which the questions are answered is not critical to conducting the present invention.

(1) In relation to incoming components (e.g., raw materials, un-machined parts, machined parts, ready-to-assemble sub-components, etc.) the following facts/issues are examined:
(a) Describe the type of metal or other corrosion susceptible material present in the incoming component (e.g., ferrous, non-ferrous, powder metal, precious metal, etc.);
(b) Describe the type of packaging, if any, that the component of interest arrives in;
(c) Where is the component of interest being shipped from, to?;
(d) Name of the supplier, or the plant, from which the component of interest originates;
(e) How is the component of interest being shipped and/or transported. How long does the component of interest sit awaiting shipment or transport?;
(f) If possible, what are the storage area conditions both prior to shipping the component of interest and/or upon arrival at a secondary plant or assembly point? In this instance, such data includes, but is not limited to, the storage temperature or temperature range, the relative humidity or relative humidity range, and/or the length of time in storage;
(g) What, if any, quality control procedures are used to inspect the incoming component of interest? If there is a quality control review, or inspection, of the incoming component of interest, are there any signs of corrosion and/or contamination revealed during such a review? It there is corrosion and/or contamination, please describe the corrosion and/or contamination, and the pattern thereof, in detail. Additionally, is the corrosion and/or contamination limited to a specific lot of the component of interest, or is this problem endemic to all lots of the component of interest. If the occurrence of corrosion and/or contamination in the component of interest is a recent phenomenon, please describe any recent changes in the method in which the component of interest is being handled. Alternatively, or in addition to, has there been a change in the manner in which the component of interest is being used?; and
(h) Additionally, it may be necessary to further quantify how any such quality control review processes are conducted. For example, is the component of interest handled by human hands, or some other contaminated and/or corrosion-causing surface, during the one or more quality control reviews? If so, what precautions and/or protective measures, if any, against such contamination and/or corrosion are taken (e.g., gloves, protective coatings, etc.)? If applicable, how often are such precautions and/or protective measures changed, reviewed for effectiveness, and/or replenished?

(2) In relation to further processed components (e.g., components that are subjected to cutting, deburring, machining, sintering, washing, drying, etc.) the following facts/issues are examined:
(a) What further processing does the component of interest undergo? Provide a detailed description of such process or processes including, but not limited to, all processing conditions, the nature of such further processing, etc.
(b) Is there any manual/human handling of the component of interest during such further processing? If so, what precautions and/or protective measures, if any, against such contamination and/or corrosion are taken (e.g., gloves, protective coatings, etc.)? If applicable, how often are such precautions and/or protective measures changed, reviewed for effectiveness, and/or replenished?;
(c) How long is the component of interest subjected to further processing, individual processing step times and total further processing time (which can include time between further processing steps);
(d) What types of processing fluids (e.g., lubricants, machining fluids, washing fluids, etc.), if any, are used in the further processing of the component of interest? Is a water-based fluid used? List the chemical and physical properties of such processing fluids. Such chemical and physical properties include, but are not limited to, fluid temperature, fluid pH, fluid composition, fluid viscosity, fluid density, etc. How often are such fluids, if any, changed?
(e) Is the component of interest shipped and/or transported during further processing. If so, how long does the component of interest sit awaiting shipment or transport? Where is the component of interest being sent to? How long is the component of interest in transit during such further processing, including any and all “down time”?;
(f) What are the shipping and/or transport conditions? In this instance, such data includes, but is not limited to, the shipping temperature or shipping temperature range, the relative humidity or relative humidity range, and/or the length of time in storage;
(g) Is the component of interest stored during further processing? If so, what are the storage area conditions both prior to shipping the component of interest and/or upon arrival at a secondary plant or assembly point? In this instance, such data includes, but is not limited to, the storage temperature or temperature range, the relative humidity or relative humidity range, and/or the length of time in storage;
(h) If applicable, how is the component of interest packaged for storage and/or transport during further processing? What, if any, corrosion and/or contamination management or mitigation techniques are utilized in connection with such packaging? If corrosion and/or contamination management or mitigation techniques are utilized, do such techniques leave any recognizable traces (e.g., residues, coatings, powder traces, etc.)?;
(i) What, if any, quality control procedures are used to inspect the component of interest during further processing? If there is a quality control review, or inspection, of the component of interest, are there any signs of corrosion revealed during such a review? It there is corrosion and/or contamination, please describe the corrosion and/or contamination, and the pattern thereof, in detail. Additionally, is the corrosion and/or contamination limited to a specific lot of the component of interest, or is this problem endemic to all lots of the component of interest. If the occurrence of corrosion and/or contamination in the component of interest is a recent phenomenon, please describe any recent changes in the one or more further processing steps to which the component of interest is being subjected. Alternatively, or in addition to, has there been a change in the manner in which the component of interest is being used?; and
(j) Additionally, it may be necessary to further quantify how any such quality control review processes are conducted. For example, is the component of interest handled by human hands, or some other contaminated surface, during the one or more quality control reviews? If so, what precautions and/or protective measures, if any, against such contamination are taken (e.g., gloves, protective coatings, etc.)? If applicable, how often are such precautions and/or protective measures changed, reviewed for effectiveness, and/or replenished?

(3) Once the component of interest, or the product of interest, is finalized a review of the packaging and shipping conditions of the component, or product, of interest is conducted. In relation to this analysis the following facts/issues are examined:
(a) Where is the component, or product, of interest being sent to? How long does the component, or product, of interest sit awaiting shipment or transport? How long is the component, or product, of interest in transit, including any and all “down time”?;
(b) What are the shipping and/or transport conditions? In this instance, such data includes, but is not limited to, the shipping temperature or shipping temperature range, the relative humidity or relative humidity range, and/or the length of time in storage;
(c) Is the component, or product, of interest subjected to storage? If so, what are the storage area conditions both prior to shipping the component of interest and/or upon arrival at a secondary plant or assembly point? In this instance, such data includes, but is not limited to, the storage temperature or temperature range, the relative humidity or relative humidity range, and/or the length of time in storage;
(d) How is the component, or product, of interest packaged for storage and/or transport during further processing? Specifically, what is the exact nature of the packaging used in connection with the storage, shipping and/or transportation of the component, or product, of interest? Such an analysis includes examining the type of packaging utilized. Such packaging can include, but is not limited to, film-based packaging, cardboard-based packaging, returnable plastic packaging, disposable plastic packaging, etc.
(e) What, if any, corrosion and/or contamination management or mitigation techniques are utilized in connection with such storage and/or packaging? If corrosion and/or contamination management or mitigation techniques are utilized, do such techniques leave any recognizable traces (e.g., residues, coatings, powder traces, etc.)?;
(f) What, if any, quality control procedures are used to inspect the component, or product, of interest during storage and/or shipping? If there is a quality control review, or inspection, of the component, or product, of interest, are there any signs of corrosion revealed during such a review? It there is corrosion and/or contamination, please describe the corrosion, and the pattern thereof, in detail. Additionally, is the corrosion and/or contamination limited to a specific lot of the component, or product, of interest, or is this problem endemic to all lots of the component, or product, of interest. If the occurrence of corrosion and/or contamination in the component, or product, of interest is a recent phenomenon, please describe any recent changes in the one or more storage and/or shipping steps to which the component, or product, of interest is subjected; and
(g) Finally, a review is conducted of the end use details of the component, or product, of interest. Such a review includes, but is not limited to, monitoring the component, or product, of interest during shipment, storage, and/or use, observing the condition of the component, or product, of interest when it arrives at its final destination (e.g., is there any condensation in the packaging; is there any corrosion on the component, or product, of interest, and if so describe same; etc.). Are all the components, or products, of interest utilized at once, or are they utilized over a given period of time? Is the component, or product, of interest subjected to further storage? If so, similar data to that discussed above with regard to storage conditions and details is collected. What, if any, corrosion and/or contamination management or mitigation techniques are utilized in connection with such final end uses? If corrosion and/or contamination management or mitigation techniques are utilized, do such techniques leave any recognizable traces (e.g., residues, coatings, powder traces, etc.)?

It should be noted that although the present invention is described with regard to certain embodiments, where such embodiments rely on the answers to a certain number of issues, the present invention is not limited thereto. That is, one does not need to answer all the questions above to design/create/use a system and/or method in accordance with the present invention. Rather, some part, or all of the questions, detailed above can be answered.

Although the invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A system for managing, mitigating, reducing, and/or eliminating corrosion in various supply chains, production chains and/or manufacturing chains comprising the steps of:
(A) determining the nature of the component, or product, to be protected;
(B) creating at least one deployment proposal and/or deployment quote;
(C) creating at least one deployment recommendation, where such deployment recommendation involves modifying or creating at least one corrosion management plan;
(D) implementing the at least one deployment recommendation; and
(E) monitoring the effectiveness of the at least one deployment recommendation.

2. The system of claim 1, wherein Step (A) is accomplished by way of a questionnaire or survey that is completed by someone familiar with either the make-up of the component, or product, to be processed, shipped, transported and/or stored.

3. The system of claim 2, wherein Step (A) involves resolving one or more of the following issues:
(1) with what component(s) and/or product(s) does a corrosion problem, or problems, exist;
(2) what type of corrosion susceptible material is the component and/or product made of, or primarily made of;
(3) what type of corrosion protection and/or mitigation, if any, is currently being utilized to protect the component and/or product of interest;
(4) what is the main reason for seeking corrosion protection of the component and/or product;
(5) is it for shipping, land transportation, long-term storage, in process protection, or any combination thereof;
(5) describe the supply chain for the component and/or product; and/or
(6) what is the desired corrosion protection period from point of packaging, shipping, or storage to point of use.

4. The system of claim 1, wherein Step (B) is accomplished by way of resolving one or more of the following issues:
(1) preparing and/or conducting a process mapping analysis;
(2) conducting a manufacturing control process review;
(3) conducting a process failure mode and effects analysis;
(4) conducting a packaging review, including a packaging design review;
(5) conducting an operator/worker review in order to determine what, if any, corrosion preventative and/or mitigation steps are being utilized, and to ascertain if such steps are being applied consistently and correctly;
(6) conducting corrosion testing on the component, or product, of interest; and
(7) conducting any applicable fluid testing.

5. The system of claim 4, wherein the corrosion tests run are selected from chip testing, drop testing, corrosion inhibiting standard test, humidity chamber testing, cyclic climate chamber test, volatile corrosion inhibiting jar test, salt spray chamber test, corrosive gas chamber test, mechanical properties testing, glow residue testing, water vapor transmission testing (WVTT ASTM E-96-00 and/or ASTM E-398-03), or combinations of two or more thereof.

6. The system of claim 1, wherein Step (C) includes one or more deployment recommendations selected from revised, improved and/or new packaging guidelines; revised, improved and/or new processing guidelines; revised, improved and/or new component and/or product handling guidelines; revised, improved and/or new corrosion management guidelines; revised, improved and/or new corrosion management implantation procedures and/or guidelines, or combinations of two or more thereof.

7. A system for managing, mitigating, reducing, and/or eliminating corrosion in various supply chains, production chains and/or manufacturing chains comprising the steps of:
(a) determining the nature of the component, or product, to be protected;
(b) creating at least one deployment proposal;
(c) creating at least one deployment quote;
(d) creating at least one deployment recommendation, where such deployment recommendation involves modifying or creating at least one corrosion management plan;
(e) implementing the at least one deployment recommendation; and
(f) monitoring the effectiveness of the at least one deployment recommendation.

8. The system of claim 7, wherein Step (a) is accomplished by way of a questionnaire or survey that is completed by someone familiar with either the make-up of the component, or product, to be processed, shipped, transported and/or stored.

9. The system of claim 8, wherein Step (a) involves resolving one or more of the following issues:
(1) with what component(s) and/or product(s) does a corrosion problem, or problems, exist;
(2) what type of corrosion susceptible material is the component and/or product made from, or primarily made from;
(3) what type of corrosion protection and/or mitigation, if any, is currently being utilized to protect the component and/or product of interest;
(4) what is the main reason for seeking corrosion protection of the component and/or product;
(5) is it for shipping, land transportation, long-term storage, in process protection, or any combination thereof;
(5) describe the supply chain for the component and/or product; and/or
(6) what is the desired corrosion protection period from point of packaging, shipping, or storage to point of use.

10. The system of claim 7, wherein Step (b) is accomplished by way of resolving one or more of the following issues:
(1) preparing and/or conducting a process mapping analysis;
(2) conducting a manufacturing control process review;
(3) conducting a process failure mode and effects analysis;
(4) conducting a packaging review, including a packaging design review;
(5) conducting an operator/worker review in order to determine what, if any, corrosion preventative and/or mitigation steps are being utilized, and to ascertain-if such steps are being applied consistently and correctly;
(6) conducting corrosion testing on the component, or product, of interest; and
(7) conducting any applicable fluid testing.

11. The system of claim 10, wherein the corrosion tests run are selected from chip testing, drop testing, corrosion inhibiting standard test, humidity chamber testing, cyclic climate chamber test, volatile corrosion inhibiting jar test, salt spray chamber test, corrosive gas chamber test, mechanical properties testing, glow residue testing, water vapor transmission testing (WVTT ASTM E-96-00 and/or ASTM E-398-03), or combinations of two or more thereof.

12. The system of claim 7, wherein Step (d) includes one or more deployment recommendations selected from revised, improved and/or new packaging guidelines; revised, improved and/or new processing guidelines; revised, improved and/or new component and/or product handling guidelines; revised, improved and/or new corrosion management guidelines; revised, improved and/or new corrosion management implantation procedures and/or guidelines, or combinations of two or more thereof.

13. A system for managing, mitigating, reducing, and/or eliminating corrosion in various supply chains, production chains and/or manufacturing chains comprising the steps of:
(i) determining the nature of the component, or product, to be protected;
(ii) creating at least one deployment proposal and/or deployment quote;
(iii) creating at least one deployment recommendation, where such deployment recommendation involves modifying or creating at least one corrosion management plan;
(iv) implementing the at least one deployment recommendation; and
(v) monitoring, at least one time, the effectiveness of the at least one deployment recommendation.

14. The system of claim 13, wherein Step (i) is accomplished by way of a questionnaire or survey that is completed by someone familiar with either the make-up of the component, or product, to be processed, shipped, transported and/or stored.

15. The system of claim 14, wherein Step (i) involves resolving one or more of the following issues:
(1) with what component(s) and/or product(s) does a corrosion problem, or problems, exist;
(2) what type of corrosion susceptible material is the component and/or product made from, or primarily made from;
(3) what type of corrosion protection and/or mitigation, if any, is currently being utilized to protect the component and/or product of interest;
(4) what is the main reason for seeking corrosion protection of the component and/or product;
(5) is it for shipping, land transportation, long-term storage, in process protection, or any combination thereof;
(5) describe the supply chain for the component and/or product; and/or
(6) what is the desired corrosion protection period from point of packaging, shipping, or storage to point of use.

16. The system of claim 13, wherein Step (ii) is accomplished by way of resolving one or more of the following issues:
(1) preparing and/or conducting a process mapping analysis;
(2) conducting a manufacturing control process review;
(3) conducting a process failure mode and effects analysis;
(4) conducting a packaging review, including a packaging design review;
(5) conducting an operator/worker review in order to determine what, if any, corrosion preventative and/or mitigation steps are being utilized, and to ascertain if such steps are being applied consistently and correctly;
(6) conducting corrosion testing on the component, or product, of interest; and
(7) conducting any applicable fluid testing.

17. The system of claim 16, wherein the corrosion tests run are selected from chip testing, drop testing, corrosion inhibiting standard test, humidity chamber testing, cyclic climate chamber test, volatile corrosion inhibiting jar test, salt spray chamber test, corrosive gas chamber test, mechanical properties testing, glow residue testing, water vapor transmission testing (WVTT ASTM E-96-00 and/or ASTM E-398-03), or combinations of two or more thereof.

18. The system of claim 13, wherein Step (iii) includes one or more deployment recommendations selected from revised, improved and/or new packaging guidelines; revised, improved and/or new processing guidelines; revised, improved and/or new component and/or product handling guidelines; revised, improved and/or new corrosion management guidelines; revised, improved and/or new corrosion management implantation procedures and/or guidelines, or combinations of two or more thereof.

19. A system for managing, mitigating, reducing, and/or eliminating contamination in various supply chains, production chains and/or manufacturing chains comprising the steps of:
(I) determining the nature of the component, or product, to be protected;
(II) creating at least one deployment proposal and/or deployment quote;
(III) creating at least one deployment recommendation, where such deployment recommendation involves modifying or creating at least one contamination management, reduction and/or elimination plan;
(IV) implementing the at least one deployment recommendation; and
(V) monitoring the effectiveness of the at least one deployment recommendation.

20. The system of claim 19, wherein Step (I) is accomplished by way of a questionnaire or survey that is completed by someone familiar with either the make-up of the component, or product, to be processed, shipped, transported and/or stored.

21. The system of claim 20, wherein Step (I) involves resolving one or more of the following issues:
(1) with what component(s) and/or product(s) does a corrosion problem, or problems, exist;
(2) what type of corrosion susceptible material is the component and/or product made from, or primarily made from;
(3) what type of corrosion protection and/or mitigation, if any, is currently being utilized to protect the component and/or product of interest;
(4) what is the main reason for seeking corrosion protection of the component and/or product;
(5) is it for shipping, land transportation, long-term storage, in process protection, or any combination thereof;
(5) describe the supply chain for the component and/or product; and/or
(6) what is the desired corrosion protection period from point of packaging, shipping, or storage to point of use.

22. The system of claim 19, wherein Step (II) is accomplished by way of resolving one or more of the following issues:
(1) preparing and/or conducting a process mapping analysis;
(2) conducting a manufacturing control process review;
(3) conducting a process failure mode and effects analysis;
(4) conducting a packaging review, including a packaging design review;
(5) conducting an operator/worker review in order to determine what, if any, corrosion preventative and/or mitigation steps are being utilized, and to ascertain if such steps are being applied consistently and correctly;
(6) conducting corrosion testing on the component, or product, of interest; and
(7) conducting any applicable fluid testing.

23. The system of claim 19, wherein Step (III) includes one or more deployment recommendations selected from revised, improved and/or new packaging guidelines; revised, improved and/or new processing guidelines; revised, improved and/or new component and/or product handling guidelines; revised, improved and/or new corrosion management guidelines; revised, improved and/or new corrosion management implantation procedures and/or guidelines, or combinations of two or more thereof.
